(19) United States
(12) Patent Application Publication
(10) Pub. No.: US 2021/0094679 A1
(43) Pub. Date: Apr. 1, 2021

(54) One-Piece Mast, Planetary Plate, and Web Carrier

(71) Applicant: Bell Textron Inc., Fort Worth, TX (US)

(72) Inventors: Colton Gilliland, Northlake, TX (US); Tyson Henry, Arlington, TX (US); Russell Mueller, Coppell, TX (US)

(73) Assignee: Bell Textron Inc., Fort Worth, TX (US)

(21) Appl. No.: 16/588,843

(22) Filed: Sep. 30, 2019

(51) Int. Cl. B64C 27/32; F01D 25/16; F16H 1/28

(52) U.S. Cl. CPC B64C 27/32; F01D 25/16; F05D 2240/60; F05D 2240/50; F16H 1/28

(57) ABSTRACT

Embodiments are directed to a rotor mast for an aircraft comprising a shaft portion, a carrier portion having a plate and a web, and frame segments that separate the web from the plate at a fixed distance. The shaft portion, the plate, the web, and the frame segments are as single component. A plurality of first holes are formed in the plate, and a plurality of second holes are formed in the web. Pairs of the first and second holes are aligned. Posts are mounted between each pair of first and second holes. Pinion gears are mounted on the posts. Roller bearings are mounted between the posts and pinion gears. An open region of the web is configured to allow a sun gear to mesh with the pinion gears.

### BACKGROUND

A rotorcraft may include one or more rotor systems. One example of a rotorcraft rotor system is a main rotor system. A main rotor system may generate aerodynamic lift to support the weight of the rotorcraft in flight and thrust to counteract aerodynamic drag and move the rotorcraft in forward flight. A rotor system may include one or more pitch links to rotate, deflect, and/or adjust rotor blades and a power source, such as an engine and transmission, to drive the rotor system. The rotor blades and transmission may be coupled by a mast. The transmission may comprise a planetary gear arrangement that provides a gear reduction to the main rotor mast.

### SUMMARY

Embodiments are directed to an integrated mast and carrier assembly, which eliminates a multitude of parts, such as nuts, bolts, planetary support bearing, etc., that are found in prior systems. A one-piece, machined carrier is much stiffer and more efficiently eliminates planetary post deflections. Additionally, as a single unit, the configuration is much lighter than traditional separate mast, planetary plate, and web carrier components.

In one aspect, embodiments are directed to a rotor mast for an aircraft. The rotor mast comprises a shaft portion and a carrier portion. The carrier portion has a plate and a web. The shaft portion, the plate, and the web are created as a single component. Pinion gears may be mounted between the plate and the web of the carrier portion. Frame segments couple the plate and the web of the carrier portion. The frame segments hold the web at a fixed distance from the plate. The rotor mast further comprises a plurality of holes in the plate portion, and a plurality of second holes in the web portion. Individual pairs of the plate holes and the web holes are aligned. Posts are mounted between each pair of holes and the pinion gears are mounted on the posts. Roller bearings may be mounted between the posts and pinion gears.

In another embodiment, a propulsion system for an aircraft comprises an engine attached to the aircraft and a proprotor system mechanically coupled to the engine. The proprotor system comprises a plurality of rotor blades, a rotor mast coupled to the plurality of rotor blades by a yoke, and a proprotor gearbox coupled to the rotor mast through a planetary gearset. The rotor mast comprises a shaft portion and a carrier portion having a plate and a web. The shaft portion, the plate, and the web are a single component. The planetary gearset has a ring gear, a sun gear, and pinion gears. The pinion gears are mounted between the plate and the web on the carrier portion. The sun gear is configured to receive torque generated by the engine and to cause the pinon gears to rotate. The rotation of the pinion gears against the ring gear causes the mast shaft to rotate.

The propulsion system may further comprise a spindle gearbox coupled to the proprotor gearbox. The rotor mast has a rotor mast axis of rotation, and the spindle gearbox is rotatable about a conversion axis. The conversion axis is oriented perpendicular to the rotor mast axis of rotation.

In another embodiment, a rotor mast for an aircraft comprises a shaft portion, a carrier portion having a plate and a web, frame segments couple the plate and the web and separate the web from the plate at a fixed distance. The shaft portion, the plate, the web, and the frame segments are manufactured as single component, such as by machining a single metal alloy blank as one piece. A plurality of first holes are formed in the plate, and a plurality of second holes are formed in the web. Pairs of the first and second holes are aligned. Posts are mounted between each pair of first and second holes. Pinion gears are mounted on the posts. Roller bearings are mounted between the posts and pinion gears. An open region of the web is configured to allow a sun gear to mesh with the pinion gears. The pinion gears are positioned to all mesh with a ring gear simultaneously. The rotor mast is configured to rotate in response to a sun gear rotating the pinion gears against a ring gear.

### BRIEF DESCRIPTION OF THE DRAWINGS

Having thus described the invention in general terms, reference will now be made to the accompanying drawings, which are not necessarily drawn to scale, and wherein:

FIG. 1 illustrates a helicopter with a main rotor gearbox and rotor assembly capable of employing embodiments of the rotor mast disclosed herein.

FIG. 2 illustrates a tiltrotor aircraft capable of employing embodiments of the rotor mast disclosed herein.

FIG. 3 illustrates detail of a propulsion system capable of employing embodiments of the rotor mast disclosed herein.

FIG. 4 is a simplified illustration of a planetary gearset that may be used in a rotorcraft drive train.

FIG. 5 depicts a one-piece mast and carrier assembly according to an example embodiment.

FIG. 6 is a detailed view of a carrier assembly as shown in FIG. 5.

FIG. 7 is a perspective view of a carrier assembly.

FIG. 8 is a cut-away side view of a carrier assembly.

While the system of the present application is susceptible to various modifications and alternative forms, specific embodiments thereof have been shown by way of example in the drawings and are herein described in detail. It should be understood, however, that the description herein of specific embodiments is not intended to limit the system to the particular forms disclosed, but on the contrary, the intention is to cover all modifications, equivalents, and alternatives falling within the spirit and scope of the present application as defined by the appended claims.

### DETAILED DESCRIPTION

Illustrative embodiments of the system of the present application are described below. In the interest of clarity, not all features of an actual implementation are described in this specification. It will of course be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming but would nevertheless be a routine undertaking for those of ordinary skill in the art having the benefit of this disclosure.

In the specification, reference may be made to the spatial relationships between various components and to the spatial orientation of various aspects of components as the devices are depicted in the attached drawings. However, as will be recognized by those skilled in the art after a complete reading of the present application, the devices, members, apparatuses, etc. described herein may be positioned in any desired orientation. Thus, the use of terms to describe a spatial relationship between various components or to describe the spatial orientation of aspects of such components should be understood to describe a relative relationship between the components or a spatial orientation of aspects of such components, respectively, as the device described herein may be oriented in any desired direction.

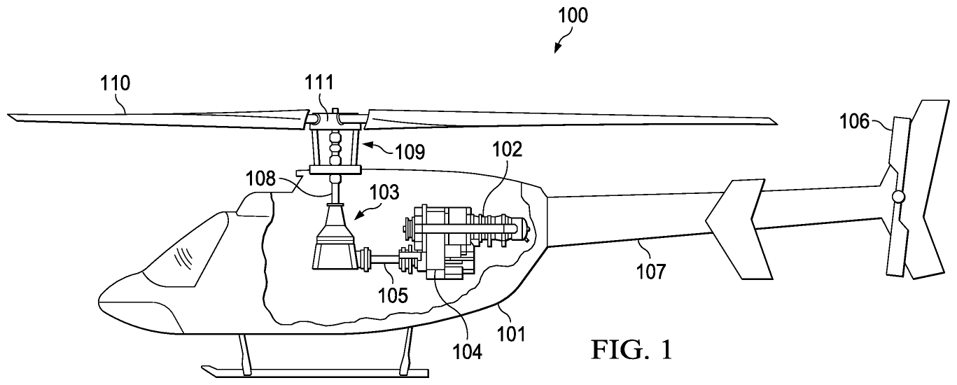

FIG. 1. illustrates a helicopter 100 comprising a fuselage 101, an engine 102, a main rotor gearbox (MRGB) 103 that is mechanically coupled to the engine 102 through a reduction gearbox 104. Reduction gearbox 104 has a drive-shaft 105 powering MRGB 103. A tail rotor 106 functions as an anti-torque system mounted on tail member 107. Reduction gearbox 104 has attachment points for the engine accessories, such a starter-generator, a fuel pump, tachometers, etc. A mast 108 mechanically couples MRGB 103 to rotor system 109. The rotor system 109 comprises rotor blades 110 that are coupled to mast 108 via a hub 111. Engine 102 supplies torque to main rotor mast 108 via MRGB 103 to rotate main rotor blades 110. Engine 102 also supplies torque to a tail rotor drive shaft to rotate tail rotor 106.

Rotor blades 110 provide lift to enable flight for helicopter 100. The rotor blades 110 are controlled by multiple controllers within fuselage 101. The pitch of each rotor blade 110 can be manipulated to selectively control direction, thrust, and lift of the helicopter 100. For example, during flight a pilot can manipulate a cyclic controller to change the pitch angle of rotor blades 110 and/or manipulate pedals to provide vertical, horizontal, and yaw flight movement. Further, the pitch of tail rotor 106 blades can be selectively controlled to selectively control yaw of helicopter 100.

MRGB 103 functions to convert high speed rotation of output drive shaft 105 of engine 102 into lower speed rotation of main rotor mast 108. MRGB 103 will typically include one or more planetary gearsets. The planetary gearset may include a central sun gear, an outer ring gear, and a plurality of planet gears rotatably coupled to a planetary carrier and configured to “orbit” the sun gear while engaging both the sun gear and the ring gear. Typically, the sun gear receives a torque input, such as from drive-shaft 105, to the planetary gearset, and the planetary carrier provides a torque output, such to rotor mast 108, from the planetary gearset.

It should be appreciated that the embodiments disclosed in the present application may be used on aircraft other than helicopters, such as airplanes, tilt rotors, and drone or unmanned aircraft, to name a few examples.

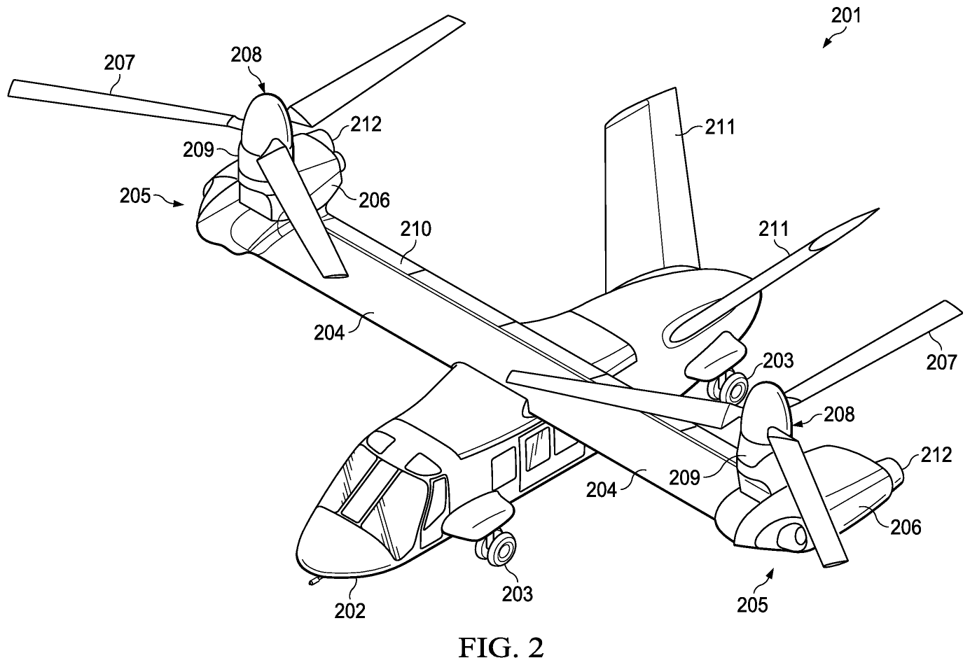

FIG. 2 illustrates a tiltrotor aircraft 201 that includes fuselage 202, landing gear 203, and wings 204. A propulsion system 205 is positioned on the ends of wings 204. Each propulsion system 205 includes an engine 206 and a proprotor 208 with a plurality of rotor blades 207. During operation, engines 206 typically maintain a constant rotational speed for their respective proprotors 207. The pitch of rotor blades 207 can be adjusted to selectively control thrust and lift of each propulsion system 205 on tiltrotor aircraft 201. The tiltrotor aircraft 201 includes controls, e.g., cyclic controllers and pedals, carried within a cockpit of fuselage 202, for causing movement of the aircraft 201 and for selectively controlling the pitch of each blade 207 to control the direction, thrust, and lift of tiltrotor aircraft 201. For example, during flight a pilot can manipulate a cyclic controller to change the pitch angle of rotor blades 207 and/or manipulate pedals to provide vertical, horizontal, and yaw flight movement.

Propulsion system 205 includes a pylon 209 that is configured to rotate proprotors 208 between an airplane mode and a helicopter mode. FIG. 2 illustrates a tiltrotor aircraft 201 in a helicopter mode wherein proprotors 207 are in a substantially vertical position to provide a lifting thrust. When operating in airplane mode, proprotors 207 are rotated forward to a substantially horizontal position. The airfoil profile of wings 204 provides vertical lift in airplane mode, and rotor blades 207 provide forward thrust. Tiltrotor aircraft 201 may also be operated such that proprotors 208 are selectively positioned between airplane mode and helicopter mode, which can be referred to as a conversion mode. Control surfaces 210 on wing 204 are used to adjust the attitude of tiltrotor aircraft 201 around the pitch, roll, and yaw axes while in airplane or conversion mode. Additional stabilizers or control surfaces 211 may be required when tiltrotor aircraft 201 is in airplane or conversion mode. Control surfaces 210 and 211 may be, for example, ailerons, flaps, slats, spoilers, elevators, rudders, or ruddervators.

Propulsion system 205 for a tiltrotor aircraft 201 typically features a power train having a mast, hub, swashplate, and pitch links within pylon 209. The mast and hub are mechanical components for transmitting torque and/or rotation from the engine 206 to the rotor blades 207. The power train may include a variety of components, including a transmission and differentials. In operation, the mast receives torque or rotational energy from engine 206 and rotates the hub, which causes blades 207 to rotate. A swashplate translates flight control input into motion of blades 207. Rotor blades 207 are usually spinning when tiltrotor aircraft 201 is in flight, and the swashplate transmits flight control input from the non-rotating fuselage 202 to the hub, blades 207, and/or components coupling the hub to blades 207 (e.g., grips and pitch horns).

FIG. 2 shows a propulsion system 205 in which engine 206 remains in a fixed position while proprotor 208, rotor blades 207, and pylon 209 rotate between the helicopter, conversion, and airplane modes. The exhaust gases from engine 206 are expelled through exhaust nozzle or tailpipe 212. In other embodiments, the entire propulsion system 205, including engine 206, may rotate relative to wing 204.

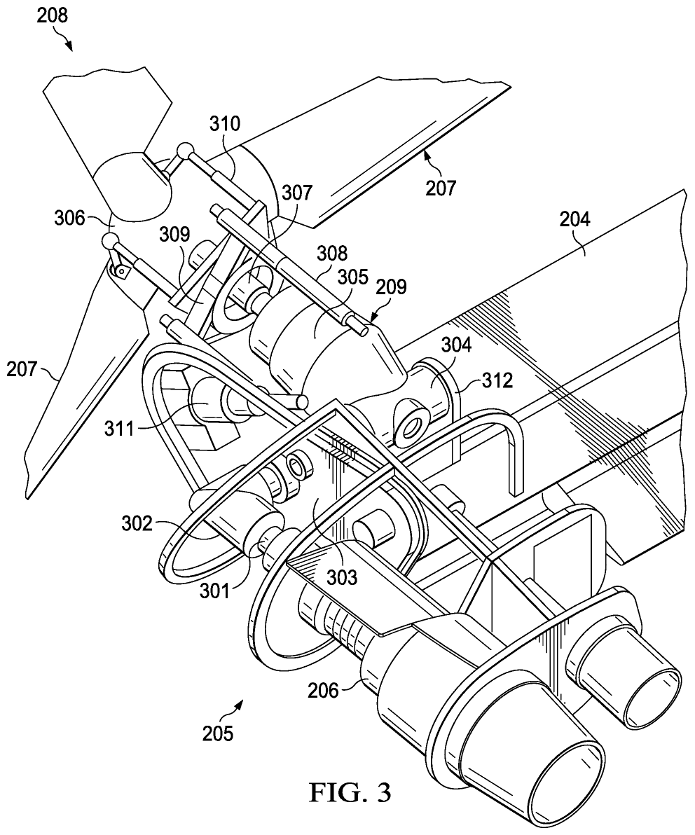

FIG. 3 illustrates further detail of propulsion system 205, which includes engine 206 that is fixed relative to wing 204. An engine output shaft 301 transfers power from engine 206 to a spiral bevel gearbox 302 that includes spiral bevel gears to change torque direction by 90 degrees from engine 206 to a fixed gearbox 303. Fixed gearbox 303 includes a plurality of gears, such as helical gears, in a gear train that are coupled to a spindle gearbox 304 of proprotor gearbox 305. The gear train provides a torque path that enables engine 206 to provide torque to proprotor 208.

Proprotor 208 includes a plurality of rotor blades 207 coupled to a yoke 306 that is coupled to a mast 307. Mast 307 is coupled to proprotor gearbox 305. The collective and/or cyclic pitch of rotor blades 207 may be controlled responsive to pilot input via actuators 308, swashplate 309, and pitch links 310. During operation, a conversion actuator 311 can be actuated so as to selectively rotate proprotor gearbox 305 and thus pylon assembly 209, which in turn selectively positions proprotor 208 between helicopter mode and airplane mode. In the illustrated embodiment, spindle gearbox 304 is rotatably coupled to the airframe of tiltrotor aircraft 201 by mounting spindle gearbox 304 to an inboard pedestal depicted as inboard pillow block 312. Thus, spindle gearbox 304 is structurally supported and is operable to be rotated about a conversion axis by conversion actuator 311. The operational loads, such as thrust loads, are transmitted through mast 307 and into spindle gearbox 304 of proprotor gearbox 305. Proprotor gearbox 305 is configured to transfer power and reduce speed to mast 307. Speed reduction is accomplished by a planetary gear assembly in proprotor gearbox 305.

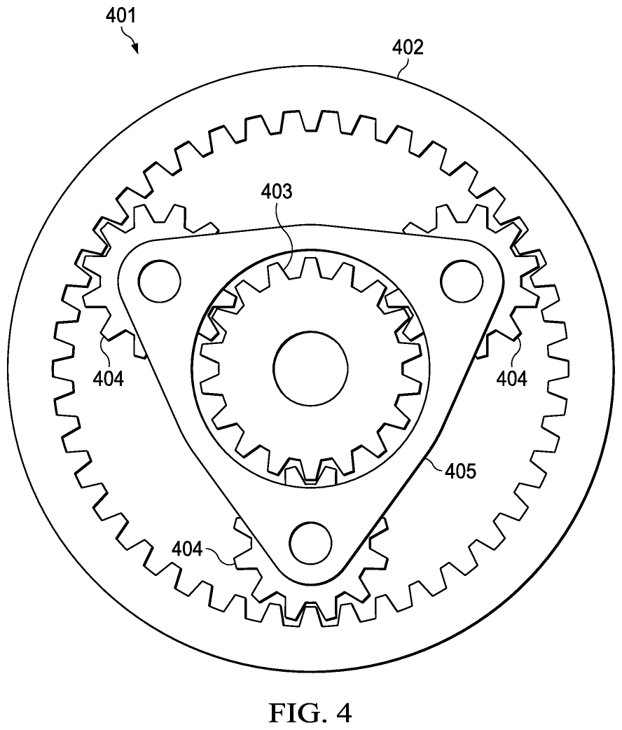

FIG. 4 is a simplified illustration of a planetary gearset 401 that may be used in a rotorcraft drive train, such as in main rotor gearbox 103 (FIG. 1) or in proprotor gearbox 305 (FIG. 3). Ring gear 402 is fixed and does not rotate. For example, ring gear 402 may be mounted in and attached to the housing of gearbox 103 or 305. Sun gear 403 is attached to a drive shaft or other input, which may be coupled to an aircraft engine though a transmission system. Rotation of the input drive shaft causes the sun gear 403 to rotate. A number of pinion gears 404 are positioned between ring gear 402 and sun gear 403. While three pinion gears 404 are illustrated in FIG. 4, it will be understood that the number of pinion gears may be selected based upon the system in which planetary gearset 401 is used. Pinion gears 404 are mounted on a carrier 405, which holds pinion gears 404 in a fixed position relative to each other.

The teeth of sun gear 402 mesh with the teeth on the inside of pinion gears 404, and the teeth on the outside of pinion gears 404 mesh with the teeth on ring gear 402. Accordingly, rotation of sun gear 402 causes pinion gears 404 to rotate. Because ring gear 402 is fixed and does not rotate, the rotation of pinion gears 404 causes these gears 404 to move along ring gear 402. As pinion gears 404 move along ring gear 402, carrier 405 rotates around the axis of, and in the same direction as, sun gear 402. Carrier 405 may be coupled to an output shaft, such as a rotorcraft mast in one embodiment. Carrier 405 is driven slower, and with more torque, than sun gear 403 creating a gear reduction.

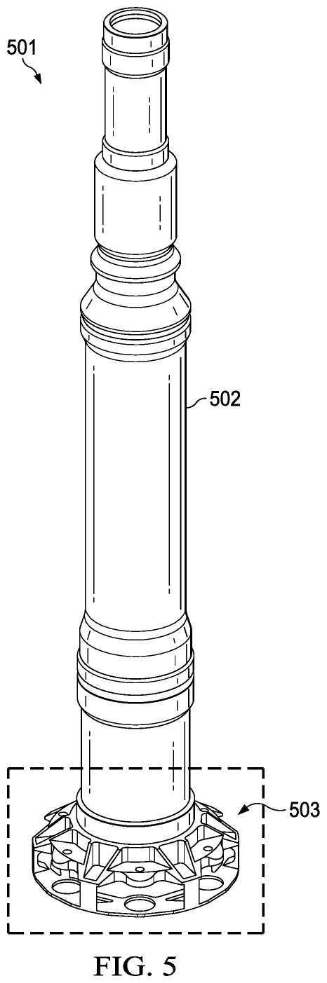

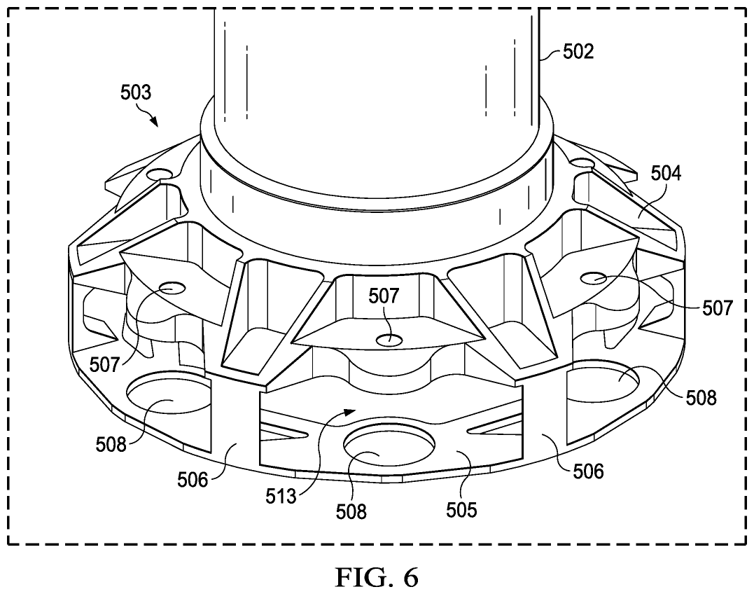

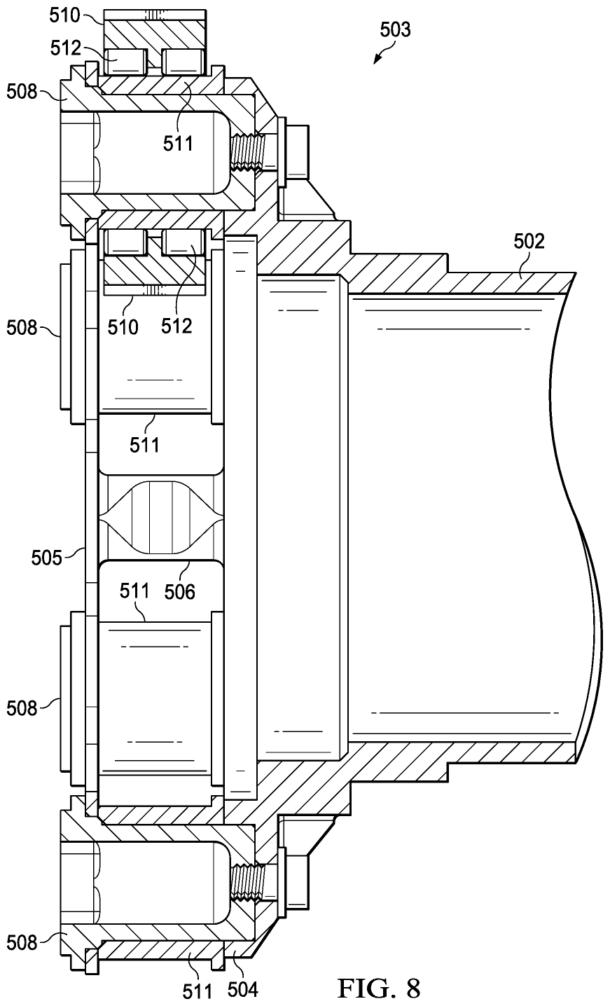

Referring to FIGS. 5-8, a one-piece mast and carrier assembly 501 is illustrated according to an example embodiment. Mast shaft portion 502 is coupled to carrier assembly portion 503. In one embodiment, mast shaft portion 502 and carrier assembly 503 are created by machining a single metal alloy blank to create an integrated mast and carrier assembly 501. Prior systems require a separate mast and planetary carrier, and the carrier is typically constructed of multiple parts. This requires excess manufacturing time and costs to join the components and adds extra components and parts that could fail individually. Such separate mast and carrier components are typically coupled together with a spline joint, which is not required in the integrated, one-piece mast and carrier assembly 501.

Carrier assembly 503 comprises a plate portion 504 and a web portion 505. A number of frame segments 506 are configured to hold the web portion 505 at a set distance from plate portion 504 and to join the web 505 and plate 504 as a single unit. Holes 507 are formed in plate portion 504 and aligned with corresponding holes 508 in web portion 505. Each pair of holes 507 and 508 are adapted to receive a post 509.

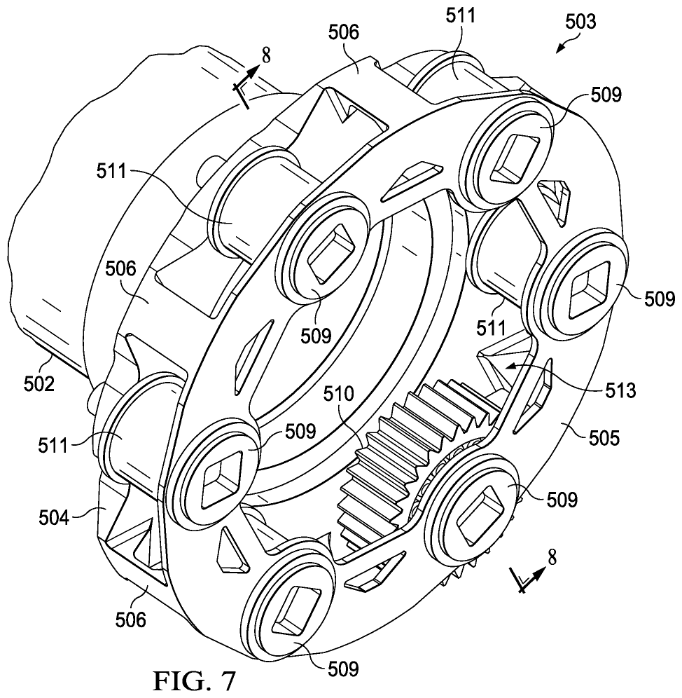

Posts 509 each support a planetary pinion gear 510, which may be mounted on an inner race 511 that is adapted to receive needle roller bearings 512 that allow pinion gear 510 to rotate freely. Although support posts 509 for six pinion gears 510 are illustrated in FIG. 7, it will be understood that the number of pinion gears may be used in other embodiments. Web portion 505 of carrier assembly 503 has a hole or open region 513 that is adapted to receive a sun gear (not shown) that meshes with the inner surface of pinion gears 510. Carrier assembly 503 is further sized to fit within a ring gear (not shown) that meshes with the outer surface of pinion gears 510.

In an example embodiment, a rotor mast for an aircraft comprises a shaft portion and a carrier portion having a plate and a web. The shaft portion, the plate, and the web are created as a single component. Pinion gears are mounted between the plate and the web of the carrier portion. Frame segments couple the plate and web on the carrier portion. The frame segments hold the web at a fixed distance from the plate. A plurality of first holes in the plate, and a plurality of second holes in the web, wherein pairs of the first and second holes are aligned. Posts are mounted between each pair of first and second holes. The pinion gears are mounted on the posts, and roller bearings are mounted between the posts and pinion gears.

In another example embodiment, a propulsion system for an aircraft comprises an engine attached to the aircraft and a proprotor mechanically coupled to the engine. The proprotor comprises a plurality of rotor blades, and a rotor mast coupled to the plurality of rotor blades by a yoke. The rotor mast comprises a shaft portion and a carrier portion having a plate and a web, wherein the shaft portion, the plate, and the web are a single component. For example, the shaft, plate, and web may be machined from a single source material, such as steel block or plate. A proprotor gearbox is coupled to the rotor mast through a planetary gearset having a ring gear, a sun gear, and pinion gears mounted on the carrier portion. The sun gear is configured to receive torque generated by the engine and to cause the pinon gears to rotate. The pinion gears are mounted between the plate and the web of the carrier portion. Frame segments couple the plate and web on the carrier portion. A plurality of first holes are formed in the plate, and a plurality of second holes are formed in the web. Pairs of the first and second holes are aligned. Posts are mounted between each pair of first and second holes, and the pinion gears are mounted on the posts. Roller bearings are mounted between the posts and pinion gears. Rotation of the pinion gears against the ring gear causes the mast shaft to rotate. A spindle gearbox is coupled to the proprotor gearbox. The rotor mast has a rotor mast axis of rotation, and the spindle gearbox is rotatable about a conversion axis, wherein the conversion axis oriented perpendicular to the rotor mast axis of rotation.

In a further embodiment, a rotor mast for an aircraft comprises a shaft portion, a carrier portion having a plate and a web, and frame segments coupling the plate and the web. The frame segments separate the web from the plate at a fixed distance. The shaft portion, the plate, the web, and the frame segments are a single component (e.g., formed from a single source material, or components welded together as a single unit). A plurality of first holes are formed in the plate, and a plurality of second holes are formed in the web. Pairs of the first and second holes are aligned. Posts are mounted between each pair of first and second holes. Pinion gears are mounted on the posts. Roller bearings are positioned between the posts and pinion gears. An open region of the web is configured to allow a sun gear to mesh with the pinion gears. The shaft portion, the plate, the web, and the frame segments may be machined from a single metal alloy blank as one piece. The pinion gears are positioned so that they all mesh with a ring gear simultaneously. The rotor mast is configured to rotate in response to a sun gear rotating the pinion gears against a ring gear.

Although the example embodiments illustrated herein show the witness tube attached to the gearbox end of the drive shaft, it will be understood that in other embodiments the witness tube may be attached to an engine output and may rotate freely at a gearbox end. Furthermore, any appropriate number of teeth may be used in the torque meter depending upon the degree of twist expected in the drive shaft. Moreover, it will be understood that the overload-inhibiting torque meter disclosed herein is not limited to use in a rotorcraft drive shaft but may be used in any application wherein preventing a drive shaft from reaching a yield torque is beneficial or advantageous. Additionally, it will be understood that systems for measuring the gap between teeth are not limited to a monopole but that any device or sensor capable of measuring a gap or interval between teeth may be used in the torque sensor.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated that the conception and specific embodiment disclosed may be readily utilized as a basis for modifying or designing other structures for carrying out the same purposes of the present invention. It should also be realized that such equivalent constructions do not depart from the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

What is claimed is:

1. A rotor mast for an aircraft, comprising:
a shaft portion; and
a carrier portion having a plate and a web, wherein the shaft portion, the plate, and the web are created as a single component.

2. The rotor mast of claim 1, wherein pinion gears are mounted between the plate and the web of the carrier portion.

3. The rotor mast of claim 1, further comprising:
frame segments that couple the plate and web on the carrier portion.

4. The rotor mast of claim 3, wherein the frame segments hold the web at a fixed distance from the plate.

5. The rotor mast of claim 1, further comprising:
a plurality of first holes in the plate, and a plurality of second holes in the web, wherein pairs of the first and second holes are aligned.

6. The rotor of claim 5, further comprising:
posts mounted between each pair of first and second holes.

7. The rotor mast of claim 6, wherein pinion gears are mounted on the posts, and further comprising:
roller bearings between the posts and pinion gears.

8. A propulsion system for an aircraft, comprising:
an engine attached to the aircraft; and
a proprotor mechanically coupled to the engine, the proprotor comprising:
a plurality of rotor blades;
a rotor mast coupled to the plurality of rotor blades by a yoke, the rotor mast comprising a shaft portion and a carrier portion having a plate and a web, wherein the shaft portion, the plate, and the web are a single component; and
a proprotor gearbox coupled to the rotor mast through a planetary gearset having a ring gear, a sun gear, and pinion gears mounted on the carrier portion, wherein the sun gear is configured to receive torque generated by the engine and to cause the pinon gears to rotate.

9. The propulsion system of claim 2, wherein the pinion gears are mounted between the plate and the web of the carrier portion.

10. The propulsion system of claim 8, further comprising:
frame segments that couple the plate and web on the carrier portion.

11. The propulsion system of claim 8, further comprising:
a plurality of first holes in the plate, and a plurality of second holes in the web, wherein pairs of the first and second holes are aligned.

12. The propulsion system of claim 11, further comprising:
posts mounted between each pair of first and second holes.

13. The propulsion system of claim 12, wherein the pinion gears are mounted on the posts, and further comprising:
roller bearings between the posts and pinion gears.

14. The propulsion system of claim 8, wherein rotation of the pinion gears against the ring gear causes the mast shaft to rotate.

15. The propulsion system of claim 8, further comprising:
a spindle gearbox coupled to the proprotor gearbox, the rotor mast having a rotor mast axis of rotation, and the spindle gearbox being rotatable about a conversion axis, wherein the conversion axis oriented perpendicular to the rotor mast axis of rotation.

16. A rotor mast for an aircraft, comprising:
a shaft portion;
a carrier portion having a plate and a web;
frame segments coupling the plate and the web, wherein the frame segments separate the web from the plate at a fixed distance, and wherein the shaft portion, the plate, the web, and the frame segments are a single component;
a plurality of first holes in the plate, and a plurality of second holes in the web, wherein pairs of the first and second holes are aligned;
posts mounted between each pair of first and second holes;
pinion gears mounted on the posts; and
roller bearings between the posts and pinion gears.

17. The rotor mast of claim 16, further comprising:
an open region of the web, the open region configured to allow a sun gear to mesh with the pinion gears.

18. The rotor mast of claim 16, wherein the shaft portion, the plate, the web, and the frame segments are machined from a single metal alloy blank as one piece.

19. The rotor mast of claim 16, wherein the pinion gears are positioned to all mesh with a ring gear simultaneously.

20. The rotor mast of claim 16, wherein the rotor mast is configured to rotate in response to a sun gear rotating the pinion gears against a ring gear.
